(19) United States
(12) Patent Application Publication
(10) Pub. No.: US 2007/0283916 A1
(43) Pub. Date: Dec. 13, 2007

(54) Plasma Iginiton Method and Device for Igniting Fuel/Air Mixtures in Internal Combustion Engines

(76) Inventors: Georg Bachmaier, Munchen (DE); Robert Baumgartner, Munchen (DE); Daniel Evers, Otterfing (DE); Thomas Hammer, Hemhofen (DE); Oliver Hennig, Munchen (DE); Gunter Lins, Erlangen (DE); Jobst Verleger, Erlangen (DE)

Correspondence Address: YOUNG & THOMPSON, 745 SOUTH 23RD STREET, 2ND FLOOR, ARLINGTON, VA, 22202, US

(21) Appl. No.: 11/659,791

(22) PCT Filed: Aug. 2, 2005
(86) PCT No.: PCT/EP05/53751

§ 371 Date: May 23, 2007

(30) Foreign Application Priority Data
Aug. 13, 2004 (DE) 10 2004 039 406.7

(51) Int. Cl. F02P 23/00

(52) U.S. Cl. 123/143 B

(57) ABSTRACT

In order to ignite fuel/air mixtures in at least one combustion chamber of a spark ignition engine, the following steps arc carried out: an HF gas discharge as the main discharge (6) is ignited in order to produce a plasma channel (11) in the region of the border between an ignition element and the combustion chamber, and an HF gas discharge as an auxiliary discharge (5) is previously or, at the most, simultaneously ignited in order to generate a flow (12) oriented towards that of the plasma channel (11). The auxiliary discharge (5) is positioned, from the combustion chamber, behind the main discharge (6), such that the oriented flow (12) presses the plasma channel (11) of the main discharge into the combustion chamber.

The invention relates to an ignition system for internal combustion engines, a method, and a device, in particular for igniting fuel/air mixtures for spark ignition gasoline engines with a direct injection.

To be able to utilize the potential of direct injecting (D1) spark ignition gasoline engines in order to reduce the fuel consumption, for example, of motor vehicles, a reliable ignition is required because cyclic fluctuations in the quality of the ignition adversely affect the degree of efficiency of the engine by incorrect ignition timing, together with increased thermal losses or incomplete combustion of the fuel load with subsequent emission, it being possible that there can be incompletely burnt hydrocarbons.

The basic requirements for a reliable ignition are as follows:

a) The development of a plasma with a sufficient energy density,

b) Development at the correct point in time,

c) Development in an area of the cylinder in which there is a fuel/air mixture that is capable of being ignited.

The required energy density of the plasma is no different in principle from that in conventional spark ignition gasoline engines in which the fuel/air mixture is produced in the carburetor and then drawn into the cylinder. However the requirements as regards the ignition time and the place of the ignition can differ:

The injection of the fuel out of the cylinder head and under a high pressure causes the formation of a hollow cone-shaped distribution of the fuel spray with a backflow zone, the space-time development of which is not only subject to systematic influences dependent on the operating point of the engine, but also to statistical fluctuations. Therefore this backflow zone approaches the cylinder head to varying degrees from injection to injection. One technical problem lies for example in achieving a reliable, timely ignition in the area of a backflow zone with means which do not extend from the cylinder head into the cylinder volume or only extend a few millimeters into the cylinder volume, since thermo-mechanical stresses would greatly shorten the service life of components extending further into the volume.

Conventional ignition systems are known in the prior art, which from an electronic high voltage impulse generator and a spark plug produce an electrode-conducted plasma with a direct current flow. This occurs between a high voltage electrode that is subjected to a pulse-shaped high voltage, said electrode, which is typically embodied in the form of a pin in an insulating body, and a ground electrode, which is often embodied in the form of a hook electrode extending from the earthed screw-in type holder or mounting. This electrode-driven plasma forms a hot, ionized zone between the electrodes, the length of which is the same as that of the electrode spacing and the diameter of which is typically 3/10 mm in the arc phase and that after 0.1 ms increases by thermal extension under simultaneous cooling (glow discharge phase). Because of its high temperature, the spatially weak extended arc phase, in which a large part of the electrical pulse energy is converted, is essentially responsible for the ignition. As a result of this localization of the plasma in the area in the vicinity of the wall, an uneven ignition occurs when said process is used in D1 spark ignition gasoline engines.

There is a plurality of basic approaches which seek to avoid the disadvantages of the conventional ignition described above:

(a) In U.S. Pat. No. 4,416,226, a localized ignition by laser impulses is disclosed, in DE 100 48 053 A1 and DE 100 50 756 A1 the combination of electrical gas discharge with an optically localized ignition of the electrical gas discharge,

(b) in U.S. Pat. No. 4,203,393, U.S. Pat. No. 4,317,068, U.S. Pat. No. 4,354,136, U.S. Pat. No. 4,471,732, U.S. Pat. No. 5,704,321 and U.S. Pat. No. 6,321,733 B1, the use of thermally-driven or magnetically-driven plasma jets is disclosed for a spatially extended ignition,

(c) in U.S. Pat. No. 6,289,068 B1, the combination of an ignition and an injection of fuel is discussed and in which the fuel injectors are for example embodied as plasma electrodes,

(d) in WO 99/20087, U.S. Pat. No. 6,633,017 B1 and U.S. Pat. No. 4,589,398, a spatially extended ignition by using extremely rapidly increasing voltages is described,

(e) in U.S. Pat. No. 5,297,510, the production of plasmas covering a large area by surface sliding discharges in a special geometry is disclosed,

(f) in DE 100 37 536 A1, DE 101 44 466 A1 and DE 102 39 410 A1 the use of high frequency voltages in the microwave range for the production of plasmas, which are not in contact with the electrodes is disclosed, and

(g) in DE 197 47 700 A1 and DE 197 47 701 A1, the production of high-impedance, short-lived plasma fibers by using sharp-edged electrode structures for the generation of an excessive increase in the field strengths in association with a radio frequency excitation is described.

Some of these approaches cannot be used in motor vehicles and other approaches require a disproportionately high energy outlay, in which case the following must be noted for the individual groups:

Re. (a): The maintenance-friendly optical access to the combustion chamber required for a light-driven method cannot be guaranteed.

Re. (b): The production of sufficiently strong magnetic fields or thermal gradients requires extremely strong flows or extremely rapidly increasing voltages in the case of strong flows, which can be problematical in practice.

Re. (c): The combination of ignition and injection is a far reaching intervention in the combustion chamber geometry which has frequently been optimized in work over many years and, as a result, encounters acceptance problems in the automotive industry.

Re. (d): The production of extremely rapidly increasing voltages requires costly electrical adapters and special measures in order to avoid EMC problems. Because considerable overvoltages may be required for a reliable ignition, problems with the electrical implementation and procedures are to be expected.

Re. (e): Surface sliding discharges, because of their bonding with the surfaces, do not solve the problem of a plasma that extends as far as possible into the cylinder volume while avoiding components which project into the cylinder volume.

Re. (f): When producing microwave plasmas in combustion chambers, interferences are utilized which are independent of the design of the combustion chamber. For this reason, there is a clash of interests between the design of the ignition system and the design of the combustion chamber resulting in a reduced acceptance in the automotive industry.

Re. (g): The generation of high-impedance, short-lived plasma fibers that extend sufficiently far into the cylinder volume, despite sharp-edged electrode structures for an excessive increase in the field strengths, demands extremely high voltage amplitudes, because the plasma-free area of the ends of the plasma fibers extending into the combustion chamber acts in the same way as a very small capacitance in relation to the widely spaced, earthed walls of the combustion chamber including the mounting of the electrode structure which is similar to that of a spark plug, at which a large part of the applied radio frequency voltage drops. Because of insulation problems, it is in practice not possible to use voltages of the required amplitude in motor vehicles. In addition, it is debatable whether or not in high-impedance plasma fibers it is possible to provide the energy density required for igniting a fuel/air mixture.

The object of the present invention is to describe a method and a device to produce an extended HF gas discharge by means of which the above-mentioned disadvantages in the prior art are avoided.

The object of the invention is achieved by means of the relevant feature combinations of claims 1 or 7.

Further advantageous embodiments of the invention are defined in the subclaims.

The invention is based on the knowledge that this can, on the one hand, be achieved by decoupling the mechanisms for the development of an HF gas discharge required for the ignition, and on the other hand, for its extension into the cylinder volume of an engine, without needing any additional resources for it in each case.

The invention is based on the fact that an auxiliary discharge by means of a corresponding electrode design and a modulation of the HF voltage amplitude on the electrode system ignites before or at the most simultaneously with a main discharge, with an auxiliary discharge igniting at an amplitude U₁ and the main discharge at an amplitude U₂>U₁. In this case, it is possible for the modulation of the HF voltage amplitude at the electrodes to be achieved both by a frequency modulation and by an amplitude modulation of the voltage source.

The invention in particular includes the case in which the auxiliary discharge ignites so early that the resulting flow of the volume, in which the main discharge ignites, is achieved before it ignites. For this purpose, because of an excessive increase in the field strength prevailing there, provision has been made for the operation of a main discharge around the central, voltage-carrying electrode. In this case, the ratio of the ignition voltage between the auxiliary discharge and the main discharge is adjusted constructively by appropriate selection of the gaps b4 (gap width earth insulation), b3 (width of the insulation) and b2 (auxiliary discharge, gap width) and, on the one hand, the radius of the central electrode as well as the dielectric permittivity εᵣ of the insulation and, on the other hand, the radius of the central electrode as well as the main gap width b1 (main discharge, gap width) to the ground electrode.

The invention is described in more detail with reference to the drawings, with the invention able to be presented in a plurality of variants.

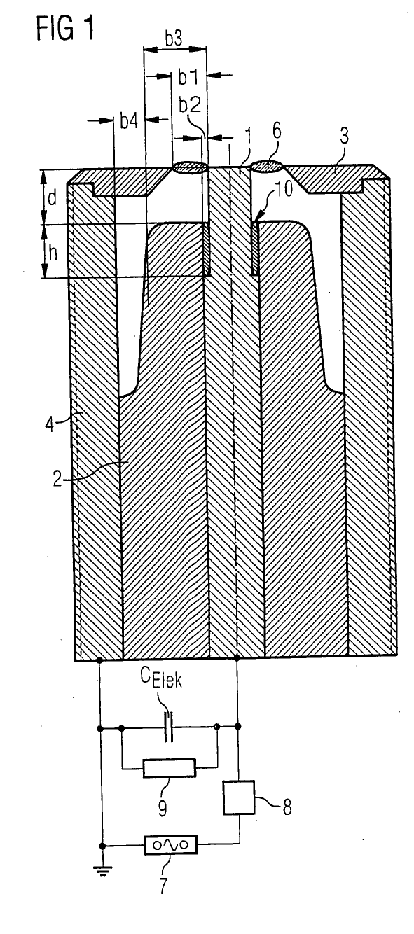

FIG. 1 shows the geometry of an HF spark plug with an auxiliary discharge zone and a main discharge zone,

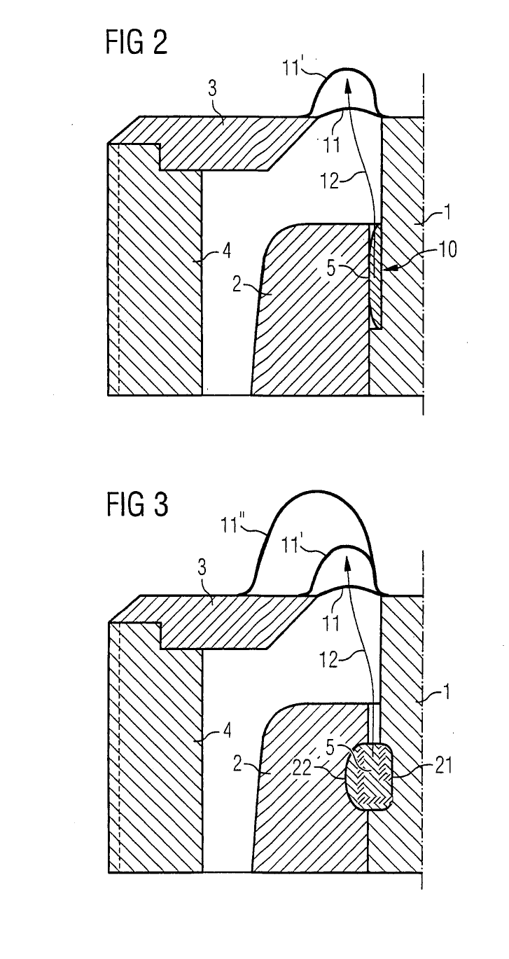

FIG. 2 shows the influence of the flow induced by an auxiliary discharge 5 on a main discharge 6,

FIG. 3 shows a modified geometry with an increased volume of a main discharge 5,

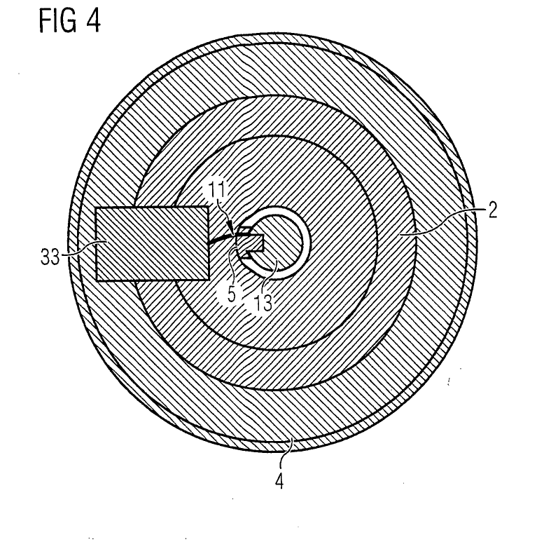

FIG. 4 shows a front view of a spark plug with electrode structures.

FIGS. 1 to 4 in each case show a cross-section through the ignition elements, for example, spark plugs. The views according to FIGS. 1 to 3 include a combustion chamber at the top. A dot-dash line represents a center axis in said figures.

The ignition of an Hf plasma in air, for a gas density n, requires an amplitude of the reduced electrical field strength E/n of at least 1.1·10⁻²² kVm². Therefore, as a result of this, in inhomogeneous electrical fields, the formation of an Hf plasma is restricted to that spatial area in which this critically reduced field strength is exceeded for the ignition. Because it is possible to exclude interference effects, this condition is fulfilled in the immediate vicinity of electrodes with structures covering a smaller area, which on the basis of the small radius of curvature; produce an excessively high increase in the field strengths. In the same way as the ambient field strength exceeds the critical value for a plasma formation, the plasma further extends itself in a channel-specific shape along the electrical field lines until it has connected the two electrodes, or the voltage applied to the electrodes no longer allows a further extension of the plasma channel 11. A requirement for this is only that an average reduced field strength clearly lies above 1.6·10⁻²³ Vm². This process of plasma propagation from the voltage-carrying electrode 1 to the counter electrode 3 times out in the case of a sufficiently stable voltage, i.e. sufficiently low impedance of the electrical supply, so quickly that gas dynamic effects do not play a role during this period.

It is possible for a plasma which is maintained by thermal ionization to be significantly influenced by gas flows. Therefore the fully formed plasma channel 11 can be blown by the flow 12, especially the gas flow directed outwards from the auxiliary discharge 5, into a cylinder volume.

The energy converted into the auxiliary discharge 5 is determined relative to the energy converted in the main discharge 6 by selecting the discharge gap width b2 and the height h of the discharge gap 10 for the auxiliary discharge 5. At the same time, these geometrical characteristics and the form of the voltage modulation determine the duration and the intensity of the flow 12 and thereby influence the arc length that can be achieved. To enable the maximum possible arc length to be achieved, the impedance of the HF voltage source and the adaptation network 8 is adapted in such a way that the plasma energy converted per arc length into the main discharge 6 does not exceed a desired value Pₘᵢₙ.

The invention further includes the clocked application of the HF voltage and in a first clock pulse by applying a low voltage amplitude, only the auxiliary discharge 5 being ignited, while in the subsequent clock pulse, by selecting a high voltage amplitude, the main discharge 6 is ignited efficiently. In this case, the time delay between the clock pulses is therefore selected in such a way that the gas flow 12 induced by the auxiliary discharge 5 arrives at the area of the main discharge 6 just as the ignition thereof is taking place. As a result of this a maximum extension of the main discharge 6 into the cylinder volume is achieved with a minimum energy consumption.

With FIG. 1 as the starting point, a capacitive or a directly coupled HF gas discharge is shown, referred to as a main discharge below, in a volume of the main discharge 6 with an energy density that is sufficient in order to ignite the fuel/air mixture between a voltage-driven electrode 1 and a counter electrode 3 connected to a ground 4 with an operating frequency f<<1 GHz in which it is possible to ignore the development of electromagnetic waves in the cylinder of the engine. The HF voltage is supplied by a generator 7 that, if need be, together with a required adaptation network 8 consisting of inductive components and capacitive components, has the complex impedance Z. In the gas discharge-free case, the electrode system 1, 3, 4 together with the insulation 2 forms a capacity C_{Electr} with a loss resistance 9. With the same electrode system and accordingly with the same HF voltage, an auxiliary discharge 5 is generated in the back space of the Hf gas discharge, the energy density of which is limited by a capacitive coupling by means of an insulation 2 and by the utilization of electron diffusion losses in narrow gaps, such that the auxiliary discharge 5 does not adversely affect the development of the main discharge 6 electrically. The auxiliary discharge according to FIG. 2 produces a pressure gradient by means of a gas heating and therefore an directed gas flow 12, which drives the plasma channel 11 of the main discharge 6 into the cylinder volume and in doing so, enlarges the spatial extension by way of a lengthened plasma channel 11′ without it being necessary to have to change the flow-conducting cross-section.

Capacitances and inductances have an impedance depending on the frequency. Thus the electrical circuit shown in FIG. 1 consisting of an Hf generator 7, an adaptation network 8, the capacitance C_{Elek} of the electrode system 1, 3, 4 with insulation 2 and a loss resistance 9, brings about a division of the supplied Hf voltage as a function of the frequency. This means that the voltage present at the electrode system 1, 3, 4 can be modulated both by a variation in the voltage amplitude and the frequency of the Hf generator.

In additional embodiments according to FIG. 3, it is possible for an even stronger extended arc at the plasma channel 11″ to be caused by structures at a center electrode 21 or at the insulation 22, which influence the volume, the ignition voltage, and the impedance of the auxiliary discharge 5.

The method and the devices based on it are not limited to cylinder symmetrical geometries, which can bring about a random incidental ignition of the auxiliary discharge and the main discharge 5, 6 around the symmetry axis. As shown in FIG. 4, it is possible, by means of electrode structures, for the electrode 13 and a counter electrode 33, the auxiliary discharge 5 and the main discharge 6, as well as the plasma channel 11 to be positioned around the circumference in such a way that the greatest possible interaction between these plasmas is guaranteed.

Compared to the prior art, the energy expended to produce a plasma covering a large area for igniting fuel/air mixtures is greatly reduced. By division into an auxiliary discharge and a main discharge 5, 6, the spatial development of the plasma channel 11, 11′ and 11″ is not exclusively brought about by its own, thermally-determined radial extension. Compared to solutions known as the prior art, this enables a main discharge with a higher energy density to be achieved. Compared to magnetic methods, the demands imposed on the flow intensity and thereby on the impedance of the voltage source and the adapting network 8 are markedly reduced. A plurality of geometrical and electrical parameters makes it possible to explicitly control an auxiliary discharge and a main discharge 5, 6 and thereby the adaptation to the specific application and different operating conditions.

1. A method for igniting fuel/air mixtures in at least one combustion chamber of a spark ignition gasoline engine, featuring the following steps:
Ignition of an HF gas discharge as the main discharge (6) to produce a plasma channel (11) in the area of the border between an ignition element and the combustion chamber, and
Ignition of an HF gas discharge preceding the main discharge or at the latest at the same time as it, as an auxiliary discharge (5) to generate a flow (12) oriented to the plasma channel (11),
with the auxiliary discharge (5), viewed from the combustion chamber, being essentially positioned behind the main discharge (6) so that the directed flow (12) pushes the plasma channel (11) of the main discharge into the combustion chamber.

2. The method as claimed in claim 1, in which a modulation of the HF voltage amplitude at the electrodes can be achieved both by a frequency modulation and by an amplitude modulation of the voltage source.

3. The method as claimed in claim 1, in which there is a time offset that can be adjusted between an auxiliary discharge and a main discharge (5, 6) and it is embodied in such a way that a directed flow (12) reaches the volume of the plasma channel (11) of the main discharge (6) before or simultaneously with the ignition of the main discharge (6).

4. The method as claimed in claim 1, in which the HF voltage is applied clocked.

5. The method as claimed in claim 4, in which, in a first clock pulse by applying a low voltage amplitude, the auxiliary discharge (5) is ignited and in a subsequent clock, pulse by selecting a high voltage amplitude, the main discharge (6) is ignited.

6. The method as claimed in claim 1, in which the flow-carrying cross section of the plasma channel (11) of the main discharge (6) is more or less constant under the influence of the flow (12).

7. A device for igniting fuel/air mixtures in a combustion chamber of a spark ignition gasoline engine for executing one of the methods as claimed in claim 1, with the following features:
a central voltage-carrying electrode (1,13), which is surrounded concentrically by a counter electrode (3) and connected to a grounding system (4), in which the counter electrode (3) and the electrode (1) more or less seal in a flush manner with a combustion chamber and form a circular main gap with the width (b1),
An insulation (2) filling the intermediate space between an electrode (1) and a counter electrode (3) or ground (4), of which the front end of said insulation comprises a gap (d) to the main discharge (6),
a discharge gap (10) embodied in the front area of the insulation (2) between an electrode (1) and an insulation (2), which is closed to the rear and features an opening in the direction of the main discharge (6),
a spacing, present-at least in the area of the discharge gap (10) which runs axially, between a counter electrode (3) or ground (4) and the insulation (2), the gap width (b4) of which is matched to the ignition of an auxiliary discharge (5).

8. The device as claimed in claim 7, in which the component contours, at which it is possible to produce a plasma channel, are embodied with small curvature radii.

9. The device as claimed in claim 7, in which for optimizing the auxiliary discharge (5), the width (b2) and the height (h) of the discharge gap (10) are matched to each other.

10. The device as claimed in claim 7, in which a ratio of the ignition voltages between the auxiliary discharge (5) and the main discharge (6) is matched by the ratio of the gaps of the gap width (b4) between earth and the insulation, of the width (b3) of the insulation and of the gap width (b2) of the auxiliary discharge one the one hand and the gap width of the main discharge (b1) on the other hand.

11. The device as claimed in claim 7, in which the operating frequency is considerably lower than 1 GHz.

12. The device as claimed in claim 7, in which the counter electrode (33) is embodied in the form of segments and interacts with the central electrode (13) for the embodiment of a plasma channel (11) and an auxiliary discharge (5).

13. The method as claimed in claim 2, in which there is a time offset that can be adjusted between an auxiliary discharge and a main discharge (5, 6) and it is embodied in such a way that a directed flow (12) reaches the volume of the plasma channel (11) of the main discharge (6) before or simultaneously with the ignition of the main discharge (6).

14. The device as claimed in claim 8, in which for optimizing the auxiliary discharge (5), the width (b2) and the height (h) of the discharge gap (10) are matched to each other.

15. The device as claimed in claim 8, in which for optimizing the auxiliary discharge (5), the width (b2) and the height (h) of the discharge gap (10) are matched to each other.

16. The device as claimed in claim 9, in which for optimizing the auxiliary discharge (5), the width (b2) and the height (h) of the discharge gap (10) are matched to each other.

17. The device as claimed in claim 8, in which the counter electrode (33) is embodied in the form of segments and interacts with the central electrode (13) for the embodiment of a plasma channel (11) and an auxiliary discharge (5).

18. The device as claimed in claim 9, in which the counter electrode (33) is embodied in the form of segments and interacts with the central electrode (13) for the embodiment of a plasma channel (11) and an auxiliary discharge (5).

19. The device as claimed in claim 8, in which the counter electrode (33) is embodied in the form of segments and interacts with the central electrode (13) for the embodiment of a plasma channel (11) and an auxiliary discharge (5).

20. The device as claimed in claim 9, in which the counter electrode (33) is embodied in the form of segments and interacts with the central electrode (13) for the embodiment of a plasma channel (11) and an auxiliary discharge (5).
